(19) United States
(12) Patent Application Publication
(10) Pub. No.: US 2011/0255316 A1
(43) Pub. Date: Oct. 20, 2011

(54) Isolating Circuit for DC/AC Converter

(76) Inventors: Bruno Burger, Freiburg (DE); Heribert Schmidt, Freiburg (DE)

(21) Appl. No.: 13/072,433

(22) Filed: Mar. 25, 2011

Related U.S. Application Data
(63) Continuation of application No. PCT/EP2009/006577, filed on Sep. 10, 2009.

(30) Foreign Application Priority Data
Sep. 25, 2008 (DE) 102008048841.0

(51) Int. Cl. H02M 7/44

(52) U.S. Cl. 363/98; 363/95; 363/97

(57) ABSTRACT

An isolating circuit for a DC/AC converter includes an input, an output, an energy storage element and a switch element. The DC/AC converter includes an energy storage isolated from mains during a freewheeling phase. The output of the isolating circuit is configured to be connected to the DC/AC converter, and the energy storage element is connected to the input and serves for storing energy received from the input. The switching element is connected between the energy storage element and the output of the isolating circuit and is operative to connect the energy storage element to the output during the freewheeling phase, and to isolate the energy storage element from the output outside the freewheeling phase of the DC/AC converter.

### CROSS-REFERENCE TO RELATED APPLICATIONS

This application is a continuation of copending International Application No. PCT/EP2009/006577, filed Sep. 10, 2009, which is incorporated herein by reference in its entirety, and additionally claims priority from German Application No. DE 102008048841.0, filed Sep. 25, 2008, which is incorporated herein by reference in its entirety.

### BACKGROUND OF THE INVENTION

Embodiments of the invention relate to the conversion of electric DC voltage to electric AC voltage by using a DC/AC converter, in particular to an isolating circuit for a DC/AC converter for isolating the same from a DC voltage energy source, such as a photovoltaic plant, a fuel cell, a battery or similar.

Starting from a DC voltage potential of a DC voltage source, it is necessitated to generate alternating current for feeding the energy into an existing alternating voltage mains, which is adapted, with respect to polarity or phase and amplitude, to the potential curve of the alternating voltage, for example a 50 or 60 Hz sinusoidally implemented mains voltage. DC/AC converters are used, for example, in the field of photovoltaics and are implemented without transformers in order to obtain high levels of efficiency. However, it is a disadvantage of the transformerless circuits that the potential of the mains is looped through the transformerless DC/AC converter to the DC voltage side and hence to the solar generator. Therewith, the solar generator is no longer potential-free (floating) and cannot be grounded either, as desired, for example, for thin-film modules.

FIG. 1 shows a single-phase DC/AC converter in an H4 bridge circuit as described, for example, in the introduction of DE 102 21 592 A1, to which reference is made with respect to more details of the mode of operation. As a DC voltage source, the circuit shown in FIG. 1 comprises a solar generator SG having DC voltage terminals 10, 12. For converting the solar generator DC voltage U_{SG} into an alternating current suitable for feeding into mains 14, the single-phase transformerless DC/AC converter shown in FIG. 1 comprises a buffer capacitor C₁ connected in parallel to a full bridge 16 consisting of 4 switch units S1 to S4.

The individual switch units S1 to S4 can be implemented as high-frequency switches able to realize, for example, switching operations having frequencies of up to several 100 kHz. Such switches can be implemented as MOS field-effect transistors or as IGBTs (insulated gate bipolar transistors).

A bridge tap occurs centrally in the parallel branches of the bridge circuit 16 at the connecting nodes 18 and 20 between switch units S1 and S2 or between switch units S3 and S4. Connecting nodes 18 and 20 are connected to AC voltage terminals 22 and 24, which are themselves connected to mains 14, via choke inductances L₁ or L₂. The bridge voltage U_{br} is applied between connecting nodes 18 and 20.

For converting the solar generator voltage U_{SG} into the alternating current necessitated for mains supply, switch units S1 to S4 are opened and closed in a predetermined high-frequency timing pattern in a synchronized manner in order to generate bridge voltages distinguishable from each other in a time-discrete manner, whose average value is tuned to the externally applied alternating voltage Uₘₐᵢₙₛ. During operation of the DC/AC converter, the bridge voltage U_{br} takes on the voltage Uₚₗᵤₛ in the case of closed switches S1 and S4, and the voltage Uₘᵢₙᵤₛ in the case of closed switch units S2 and S3.

The single-phase DC/AC converters 1 in a H4 bridge circuit described in Fig. are, for example, clocked in a bipolar manner, wherein the two output chokes L₁ and L₂ are provided to prevent potential jumps at the solar generator SG. Such potential jumps are unwanted, since the solar generator SG has a large capacity towards ground and a large capacitive charge-reverse current would flow at a potential jump. By the bipolar clocking performed across the diagonal and the usage of symmetrical output chokes, half the amplitude of the mains voltage Uₘₐᵢₙₛ is superimposed on the solar generator voltage U_{SG}. Since this is an impressed voltage, the solar generator SG floats with sinusoidal potential to ground.

FIG. 2 illustrates the DC voltages of the solar generator to ground, wherein the DC/AC converter is illustrated in a simplified manner in FIG. 2 and provided with reference numeral 26.

The disadvantage of bipolar clocking as described above based on FIG. 1 is that the obtainable efficiency is only very low. Higher efficiency could be obtained with unipolar clocking or with the so-called single-phase chopping, since here unipolar voltages are generated at the output of the bridge 16 and hence the current ripple in the choke is significantly reduced compared to bipolar clocking, however such clocking methods have disadvantages that do not allow usage in the conversion of a DC voltage, for example a DC voltage provided by a solar generator. In unipolar clocking or single-phase chopping of the bridge, the solar generator SG would show clock-frequent potential jumps to ground, which would result in large capacitive output currents, so that these just described, basically advantageous clocking types cannot be used.

The problems just described with respect to the efficiency of single-phase DC/AC converters in H4 bridge circuit can be solved by the circuits described based on FIGS. 3 and 4, namely the Heric® circuit according to DE 102 21 592 A1 shown in FIG. 3 and by the H5 circuit according to DE 10 2004 030 912 B3 shown in FIG. 4. In the following, only the basic structure of these two known circuits according to the stated publications will be discussed, and regarding a more detailed discussion of the functional principle of these circuits, reference is made to the stated publications.

In addition to the circuit shown in FIG. 1, the circuit shown in FIG. 3 comprises two parallel connecting paths between bridge taps 18 and 20, wherein one switch S5 or S6 as well as a rectifier diode D₁ or D₂ connected in series are provided in each of them, wherein the rectifier diodes in the individual connecting paths are mutually switched in opposite forward direction. In addition to the circuit described in FIG. 1, in the circuit according to FIG. 4, switch S5 is provided between direct current terminal 10 and bridge 16. Due to their structure, the circuits described based on FIGS. 3 and 4 allow switching of a so-called freewheeling path.

In the circuit according to FIG. 3, the positive freewheeling current flows across the transistor or switch S5 and the diode D_{I}, and the negative freewheeling current runs across the transistor or switch S6 and the diode D₂. During freewheeling, the solar generator is turned off by switches or transistors S1 to S4, so that the same does not experience any potential jumps.

The situation is similar in the H5 circuit shown in FIG. 4. Here, the positive freewheeling current flows across the transistor S1 and the freewheeling diode of transistor S3, and the negative freewheeling current runs across the transistor S3 and the freewheeling diode of transistor S1. Here, during freewheeling, the solar generator SG is isolated by switches or transistors S2, S4 and S5.

By the circuits described based on FIGS. 3 and 4, levels of efficiency that are 1 to 2% higher compared to the levels of efficiency obtainable with the circuit shown in FIG. 1 can be obtained.

FIG. 5 shows the voltage of the solar generator to ground in the single-phase transformerless DC/AC converters described based on FIGS. 1, 3 and 4. As can be seen, in the potential of the solar generator to ground, half the mains voltage amplitude is superimposed. In all cases, the solar generator floats with a sinusoidal potential to ground and cannot be grounded since this would result in a direct path between solar generator SG and mains 14.

This may be acceptable for many implementations of solar generators, however, solar generators exist where grounding is desired, in particular when such solar generators use thin-film modules or rear-side contacted solar cells. In thin-film modules, grounding is desired for preventing premature aging of the thin-film modules. Further, grounding of the solar generator may be mandatory in some countries due to national standards.

### SUMMARY

According to an embodiment, an isolating circuit for a DC/AC converter, wherein the DC/AC converter has an energy storage isolated from mains during a freewheeling phase, may have: an input; an output connectable to the DC/AC converter; an energy storage element connected to the input and operative to store energy received from the input; and a switching element connected between the energy storage element and the output, wherein the switching element is operative to connect the energy storage element to the output during the freewheeling phase of the DC/AC converter, and to isolate the energy storage element from the output outside the freewheeling phase of the DC/AC converter.

According to another embodiment, a system may have: a solar generator connected to a reference potential; a DC/AC converter implemented to convert a DC voltage provided by the solar generator into an AC voltage and to provide it to an output of the DC/AC converter, wherein the DC/AC converter is further implemented to isolate an energy storage of the DC/AC converter from the output of the DC/AC converter during a freewheeling phase; and an inventive isolating circuit.

According to another embodiment, a DC/AC converter circuit for converting a received DC voltage into an AC voltage may have: an input; an output; an energy storage; a switching network connected between the energy storage and the output and operative to isolate the energy storage from the output during a freewheeling phase and to connect the energy storage to the output outside the freewheeling phase; and an inventive isolating circuit connected between the input and the energy storage.

According to another embodiment, a method for converting a DC voltage provided by a solar generator connected to a reference potential into an AC voltage may have the steps of: outside a freewheeling phase of a DC/AC converter, when an energy storage connected to the input of the DC/AC converter is connected to an output of the DC/AC converter, isolating the solar generator from the DC/AC converter and temporarily storing the energy provided by the solar generator; and during the freewheeling phase of the DC/AC converter, during which the energy storage of the DC/AC converter is isolated from the output of the DC/AC converter, charging the energy storage of the DC/AC converter.

According to embodiments of the invention, the intermediate circuit capacitor C₁ of the DC/AC converter (see FIGS. 1 to 4) is charged by a grounded solar generator during the freewheeling phase of the DC/AC converter, since the intermediate circuit capacitor C₁ is isolated from mains potential during that time. Outside the freewheeling phases, when the intermediate circuit capacitor is connected to mains via the bridge transistors or bridge switches, the grounded solar generator is isolated, which prevents a short-circuit. According to embodiments of the invention, this isolation is performed with two additional transistors or switches. In order for the solar generator to provide energy during isolation, a further input capacitor C₀₁ is provided as energy storage.

### BRIEF DESCRIPTION OF THE DRAWINGS

Embodiments of the present invention will be detailed subsequently referring to the appended drawings, in which:

FIG. 1 is a circuit diagram of a single-phase DC/AC converter in H4 bridge circuit;

FIG. 2 is an illustration of the definition of the DC voltages of the solar generator to ground;

FIG. 3 is a schematic diagram of a conventional DC/AC converter;

FIG. 4 is a schematic diagram of a DC/AC converter in H5 circuit;

FIG. 5 is the DC voltage curves of the solar generator to ground when using the single-phase transformerless DC/AC converters according to FIGS. 1, 3 and 4;

FIG. 6 is the schematic diagram of an embodiment of the invention consisting of an energy storage, an isolator and a DC/AC converter, wherein in FIG. 6(a) the negative pole of the solar generator is grounded, and wherein in FIGS. 6(b) the positive pole of the solar generator is grounded;

FIG. 7(a) is an embodiment of the isolating circuit with a capacitor as buffer storage and two electronic switches;

FIG. 7(b) is the isolating circuit shown in FIG. 7(a) having a further diode for suppressing a back current into the capacitor and having a solar generator whose negative pole is grounded;

FIG. 7(c) is the isolating circuit shown in FIG. 7(a) having a further diode for suppressing a back current into the capacitor and having a solar generator whose positive pole is grounded;

FIG. 8 is the DC voltage curves of the solar generator to ground when using the isolating means according to embodiments of the invention, wherein FIG. 8(a) shows the DC voltage curves for a solar generator whose negative pole is grounded, and wherein FIG. 8(b) shows the DC voltage curves for a solar generator whose positive pole is grounded;

FIG. 9(a) is a further embodiment of the invention having a capacitor as a buffer storage and two electronic switches, two choke coils and a freewheeling diode;

FIG. 9(b) is the embodiment shown in FIG. 9(a) having a further diode for suppressing a back current in the capacitor and having a solar generator whose negative pole is grounded;

FIG. 9(c) is the embodiment shown in FIG. 9(a) having a further diode for suppressing a back current into the capacitor and having a solar generator whose positive pole is grounded;

FIG. 10 is the usage of the isolating means according to FIG. 7(a), FIG. 7(b) and FIG. 7(c) having a conventional DC/AC converter circuit according to FIG. 3 (FIG. 10(a), FIG. 10(b) and FIG. 10(c));

FIG. 11 is the usage of the isolating means according to FIG. 7(a), FIG. 7(b) and FIG. 7(c) having a conventional DC/AC converter circuit according to FIG. 4 (FIG. 11(a), FIG. 11(b) and FIG. 11(c));

FIG. 12 is the usage of the isolating means according to FIG. 9(a), FIG. 9(b) and FIG. 9(c) having a conventional DC/AC converter circuit according to FIG. 3 (FIG. 12(a), FIG. 12(b) and FIG. 12(c)); and

FIG. 13 is the usage of the isolating means according to FIG. 9(a), FIG. 9(b) and FIG. 9(c) having a conventional DC/AC converter circuit according to FIG. 4 (FIG. 13(a), FIG. 13(b) and FIG. 13(c)).

### DETAILED DESCRIPTION OF THE INVENTION

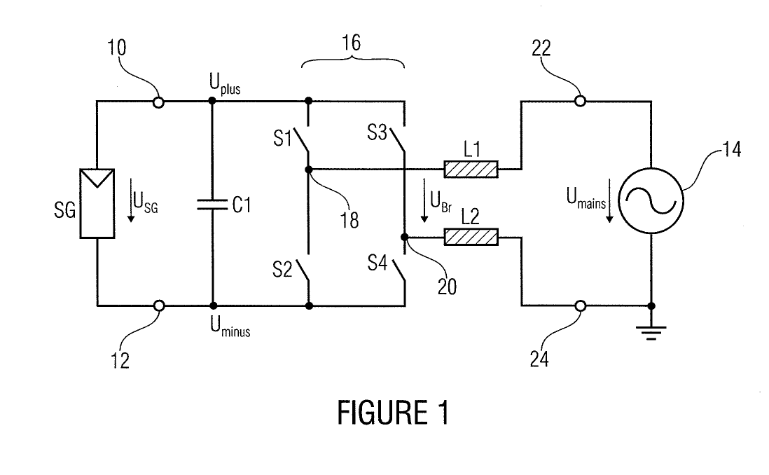

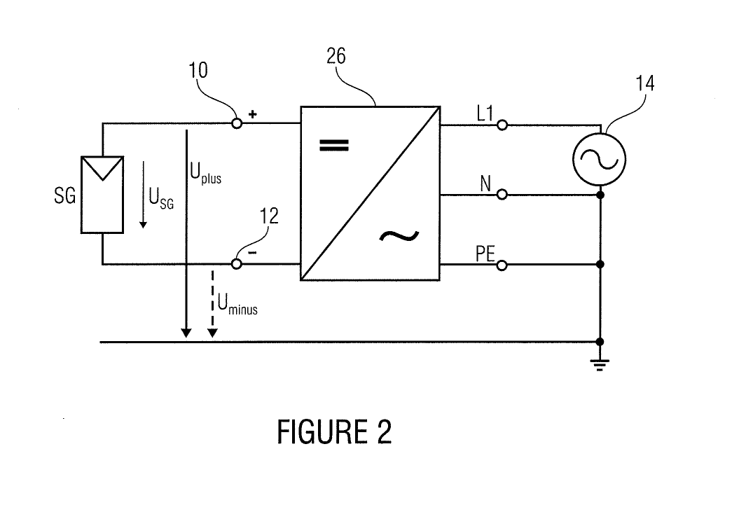

In the following description of the embodiments of the invention, the same elements or equal elements are provided with the same reference numbers. Elements already described based on FIGS. 1 to 5 will not be described again in detail and in this regard reference is made to the above statements.

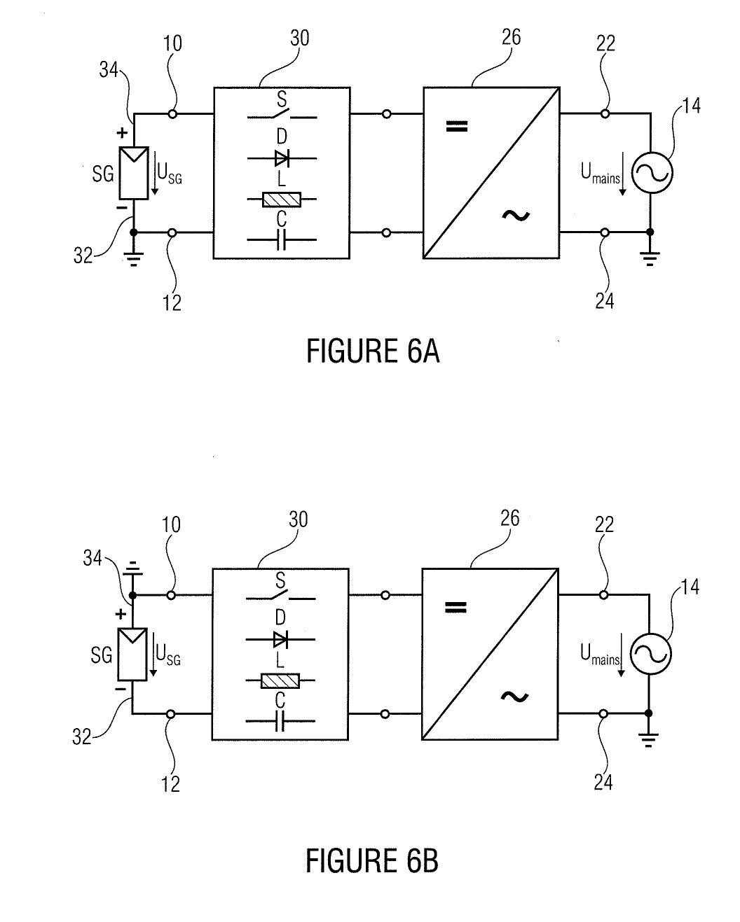

FIG. 6(a) shows an embodiment of the invention where an isolating means 30 is connected between the solar generator SG and the DC/AC converter 26. In the embodiment shown in FIG. 6, the negative pole 32 of the solar generator SG is grounded. The further embodiments also describe a solar generator SG whose negative pole 32 is grounded. It should be noted that the present invention is not limited to such an implementation. Rather, the positive pole 34 of the solar generator can also be grounded, as shown in FIG. 6(b). The present invention is also not limited to a connection of one of the poles of the solar generator SG to ground, but rather the solar generator SG can be connected to any predetermined reference potential, for example by providing an additional voltage source for connecting potentials of the solar generator differing from zero to ground, wherein the voltage source can either be part of the solar generator or an additional external voltage source.

FIG. 6(a) and FIG. 6(b) show schematically the isolating means 30 according to embodiments of the invention which allows to decouple the solar generator SG from mains 14, wherein the isolating means 30 additionally comprises one or several switches S, as well as at least one energy storage element, for example in the form of a capacitor C. Optionally, further choke elements L or rectifier diodes D can additionally be provided. The isolating means 30 allows the intermediate circuit capacitor C₁ of the DC/AC converter 26 to be charged by the grounded solar generator SG during the freewheeling phase of the DC/AC converter, since the same is isolated from mains potential during the freewheeling phase. During the phase when the intermediate capacitor is connected to mains, switches S isolate the solar generator SG, which prevents a short-circuit.

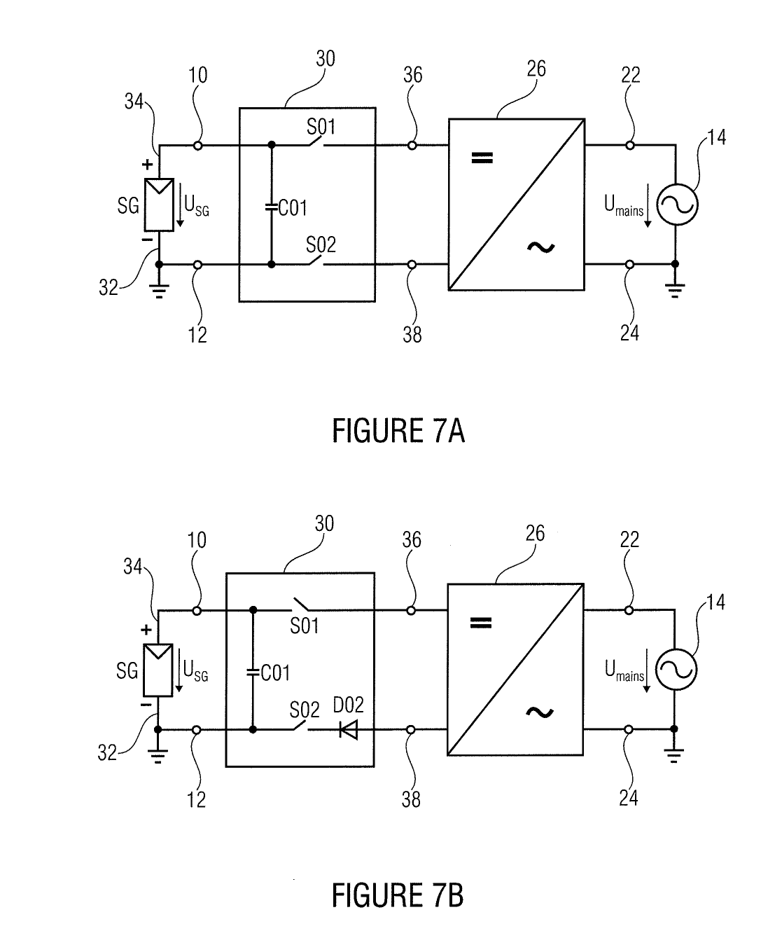

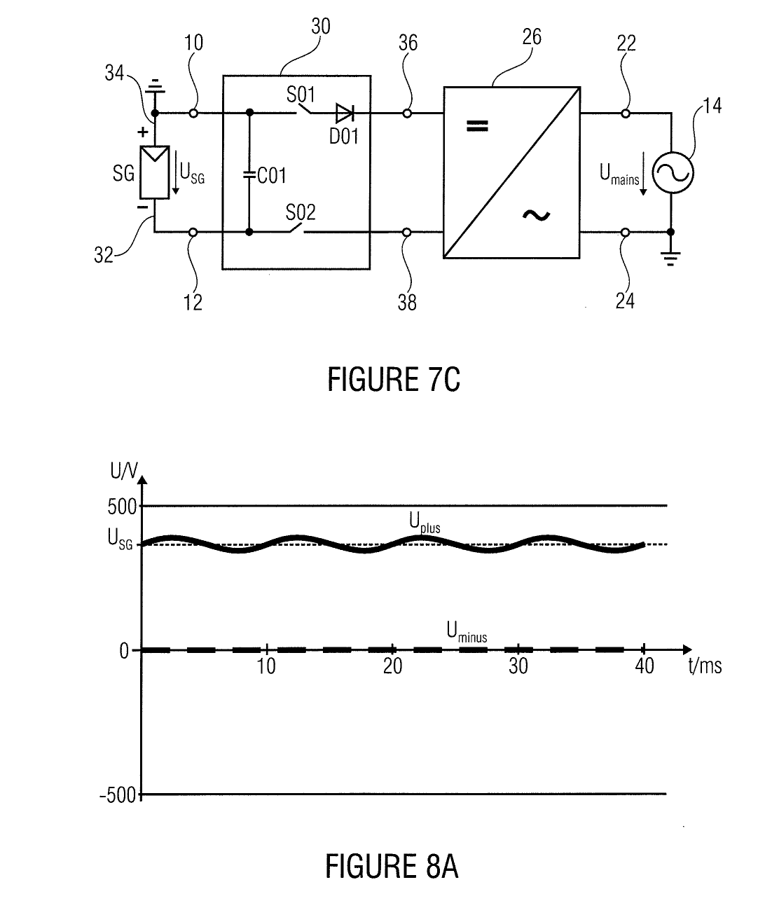

FIG. 7(a) shows a simple example of a possible implementation of the isolating means according to embodiments of the invention, wherein the isolating means 30 is connected between the direct current terminals 10, 12 of the solar generator SG and the input terminals 36 and 38 of the DC/AC converter 26. In the embodiment shown in FIG. 7, the isolating means 30 comprises the two switches S₀₁ and S₀₂, which can be implemented, for example, as electronic switches or transistors, as well as the capacitor C₀₁ as energy storage. Energy storage C₀₁ is connected in parallel to terminals 10, 12, i.e. the input of the isolating means 30, and switch S₀₁ is connected in series between a first input terminal 10 and a first output terminal 36 of the isolating circuit 30. Switch S_{O2} is connected between a second terminal 12 of the input of the isolating circuit 30 and a second terminal 38 of the output of the isolating circuit 30. Switches S₀₁ and S₀₂ are controlled in the DC/AC converter 26 during the freewheeling phase, so that the energy storage capacitor C₁ of the DC/AC converter, which is isolated from mains during this freewheeling phase can be charged by the energy temporarily stored in the energy storage C₀₁ of isolating means 30. Outside the freewheeling phase of the DC/AC converter 26, i.e. during the time when the capacitor C₁ of the DC/AC converter 26 is connected to mains, switches S₀₁ and S_{O2} are open to prevent the short-circuit between grounded solar generator SG and grounded mains. At the same time, the energy storage element C₀₁ allows the energy provided by the solar generator SG to be also temporarily stored by the energy storage element C₀₁ of the isolating means 30 outside the freewheeling phase of the DC/AC converter 26 for a later release to the DC/AC converter.

FIGS. 7(b) and 7(c) show modifications of the embodiment of FIG. 7(a) where switches S₀₁ and/or S₀₂ are realized by transistors. Such transistors may have inverse diodes that still allow back current into capacitor C₀₁ during isolation of capacitor C₀₁ from mains 14. In order to prevent unwanted back current into the capacitor C₀₁ due to the inverse diodes of the transistors, in such an implementation, diodes D₀₁ and D₀₂ are additionally provided. In the circuit according to FIG. 7(b) having a solar generator SG whose negative pole is grounded, the diode D₀₂ is connected between switch (transistor) S₀₂ and node 38. In the circuit according to FIG. 7(c) having a solar generator SG whose positive pole is grounded, the diode D₀₁ is connected between switch (transistor) S₀₁ and node 36. Alternatively, the diode D₀₁ or D₀₂ can also be arranged before switch S₀₁ or S₀₂, which means between capacitor C₀₁ and switch S₀₁ or S₀₂.

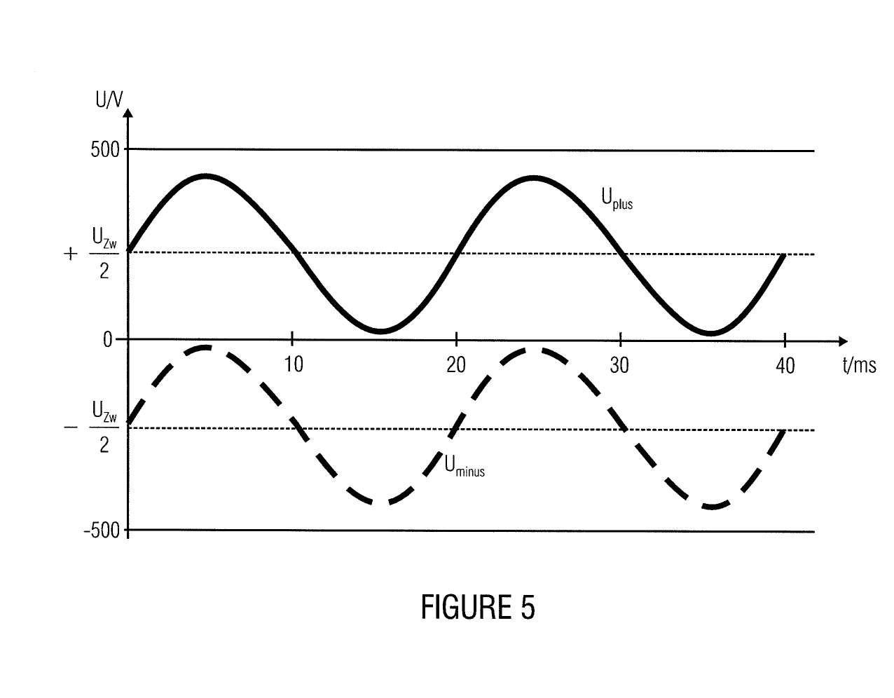

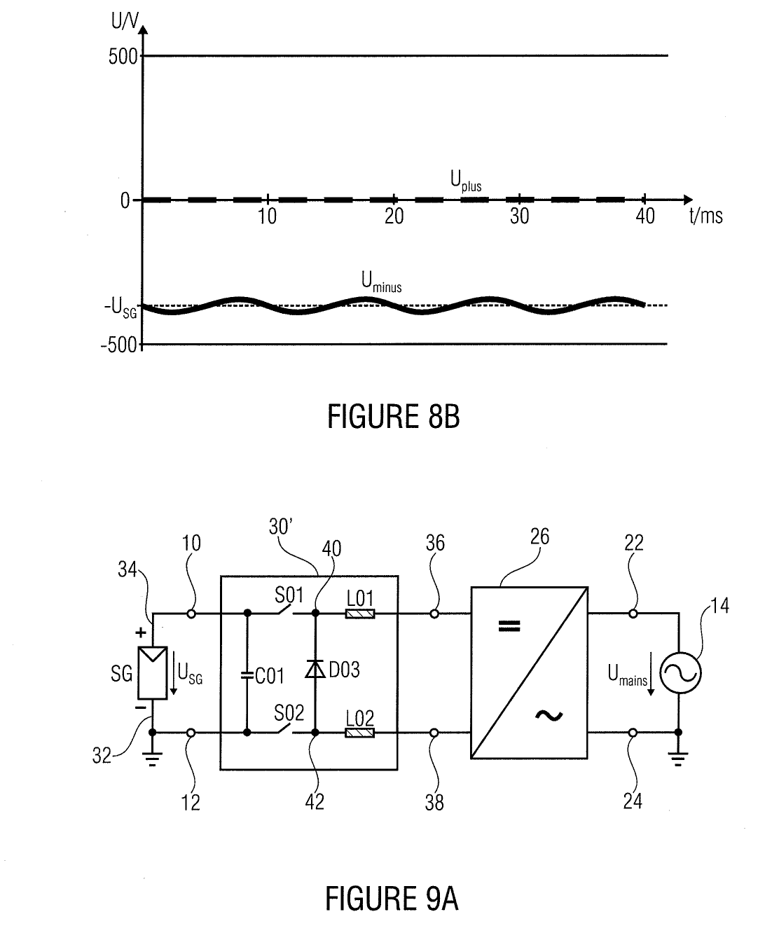

FIG. 8 shows the DC voltage curves of the solar generator SG to ground when using the isolating means as described, for example, based on FIG. 7. FIG. 8(a) shows the DC voltage curves for a solar generator whose negative pole is grounded, and FIG. 8(b) shows the DC voltage curves for a solar generator whose positive pole is grounded. FIG. 8 shows the potentials of the solar generator again to ground, and a comparison with FIG. 5 shows that by using the isolating means according to embodiments of the invention, the sinusoidal portion of Uₚₗᵤₛ (FIG. 8(a)) or Uₘᵢₙᵤₛ (FIG. 8(b)), as would conventionally occur (see FIG. 5), has been substantially eliminated. Further, the potential of the negative pole (FIG. 8(a)) or the positive pole (FIG. 8(b)) is on zero, since the same is grounded.

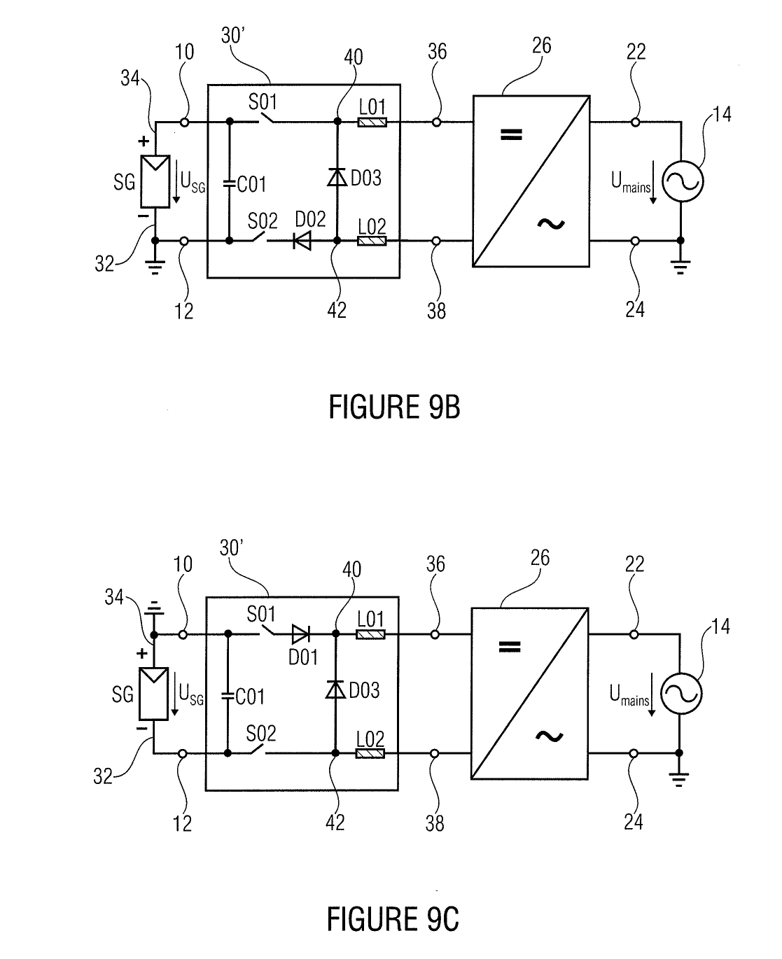

FIG. 9(a) shows an isolating circuit according to a further embodiment of the invention, again having a capacitor C₀₁ as a buffer storage and the two electronic switches S₀₁ and S₀₂ that have already been described based on FIG. 7. Additionally, the isolating circuit 30′ according to FIG. 9 comprises the two choke coils L₀₁ and L₀₂ as well as the freewheeling diode D₀₃. Choke coil L₀₁ is connected in series between the switch S₀₁ and the first terminal 36 of the output of the isolating circuit 30′, and the second choke coil S₀₂ is connected in series between the switch S₀₂ and the second terminal 38 of the output of the isolating means 30′. Freewheeling diode D₀₃ is connected between the node 40 between switch S₀₁ and choke coil L₀₁ and the node 42 between switch S₀₂ and choke coil L₀₂.

Similar to FIGS. 7(b) and 7(c), FIGS. 9(b) and 9(c) show modifications of the embodiment of FIG. 9(a), where switches S₀₁ and/or S₀₂ are realized by transistors. Such transistors can possibly have inverse diodes that still allow a back current into the capacitor C₀₁ during an isolation of the capacitor C₀₁ from mains 14. In order to prevent the unwanted back current into the capacitor C₀₁ due to the inverse diodes of the transistors in such an implementation, diodes D₀₁ or D₀₂ are additionally provided. In the circuit according to FIG. 9(b) having a solar generator SG whose negative pole is grounded, the diode D₀₂ is connected between switch (transistor) S₀₂ and node 42. In the circuit according to FIG. 9(c) having a solar generator SG whose positive pole is grounded, the diode D₀₁ is connected between switch (transistor) S₀₁ and node 40. Alternatively, diode D₀₁ or D₀₂ can also be arranged before switch S₀₁ or S₀₂, i.e. between capacitor C₀₁ and switch S₀₁ or S₀₂. Again, in an alternative implementation, diode D₀₁ or D₀₂ can also be arranged after choke coil L₀₁ or L₀₂, i.e. between choke coil L₀₁ or L₀₂ and node 36 or 38.

As in the embodiments described based on FIG. 7, in the embodiments described based on FIG. 9, transistors S₀₁ and S₀₂ are also only controlled during the freewheeling phase of the DC/AC converter 26, and by pulse width modulation, the current in choke coils L₀₁ or L₀₂ can be regulated. Compared to the implementations described based on FIG. 7, the circuits according to FIG. 9 are advantageous, since here the input voltage at the capacitor C₀₁ can be regulated independently of the voltage of the capacitor C₀₁ in the DC/AC converter 26.

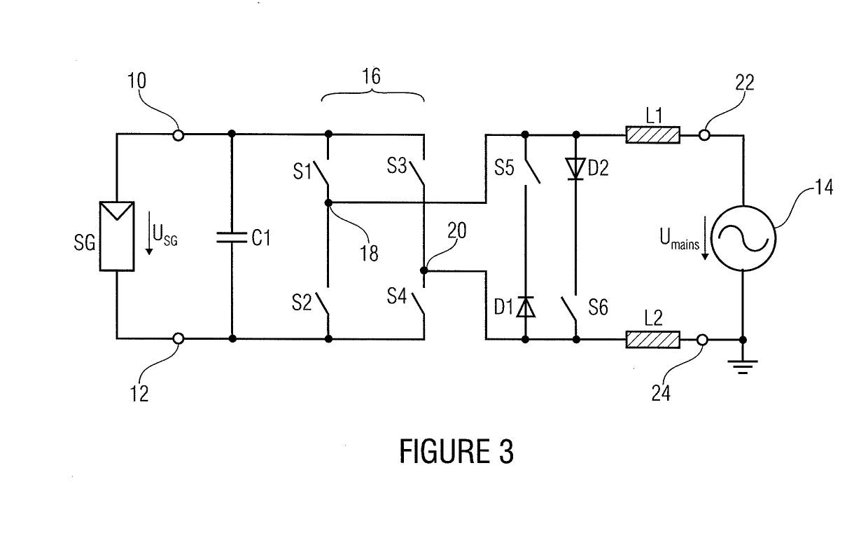

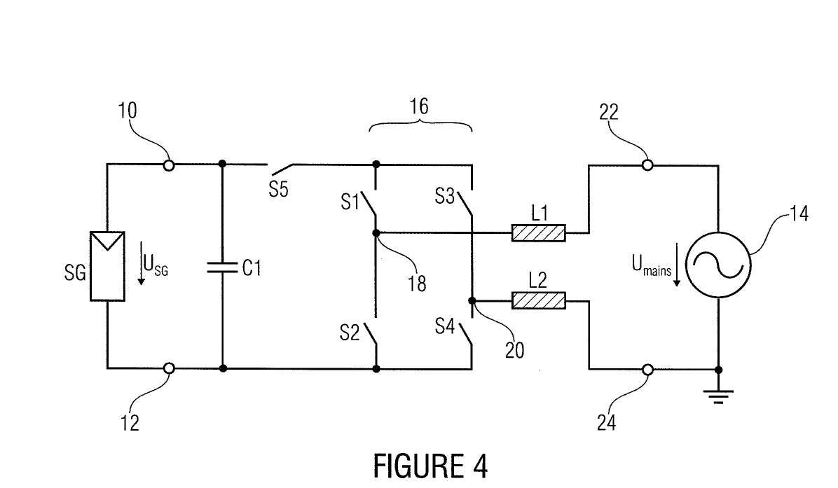

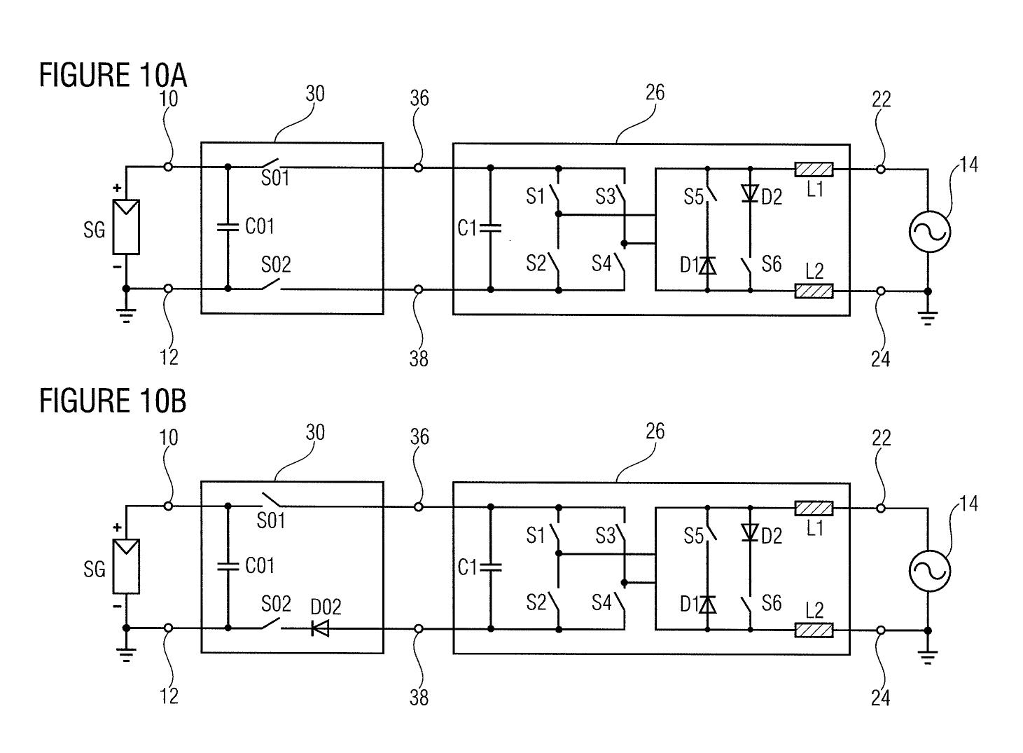

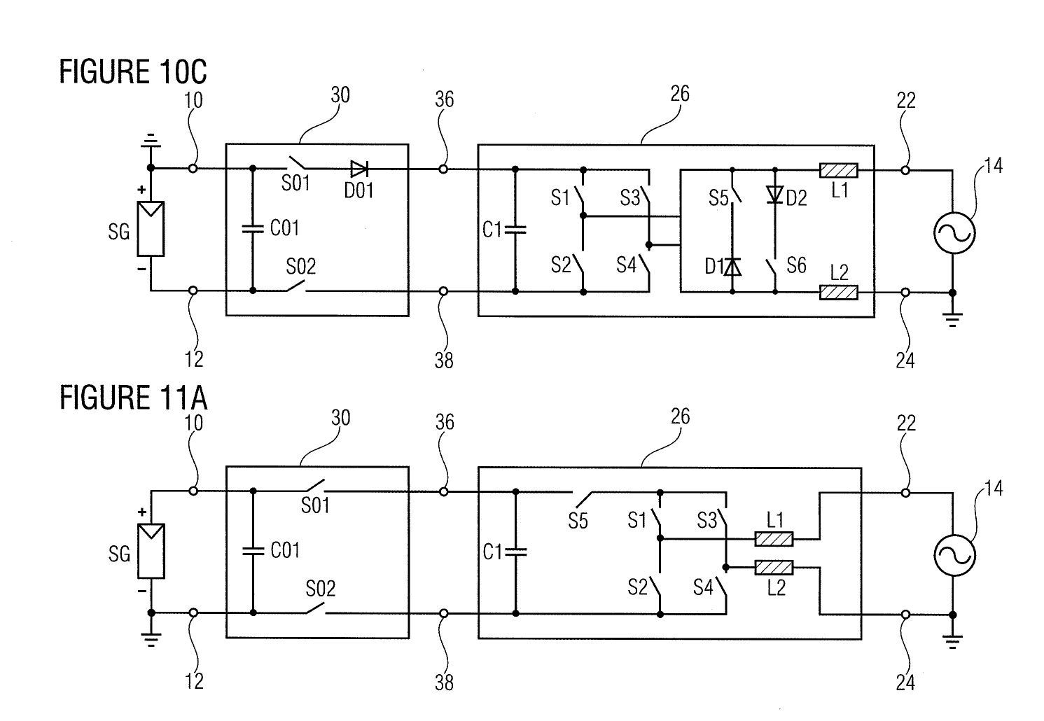

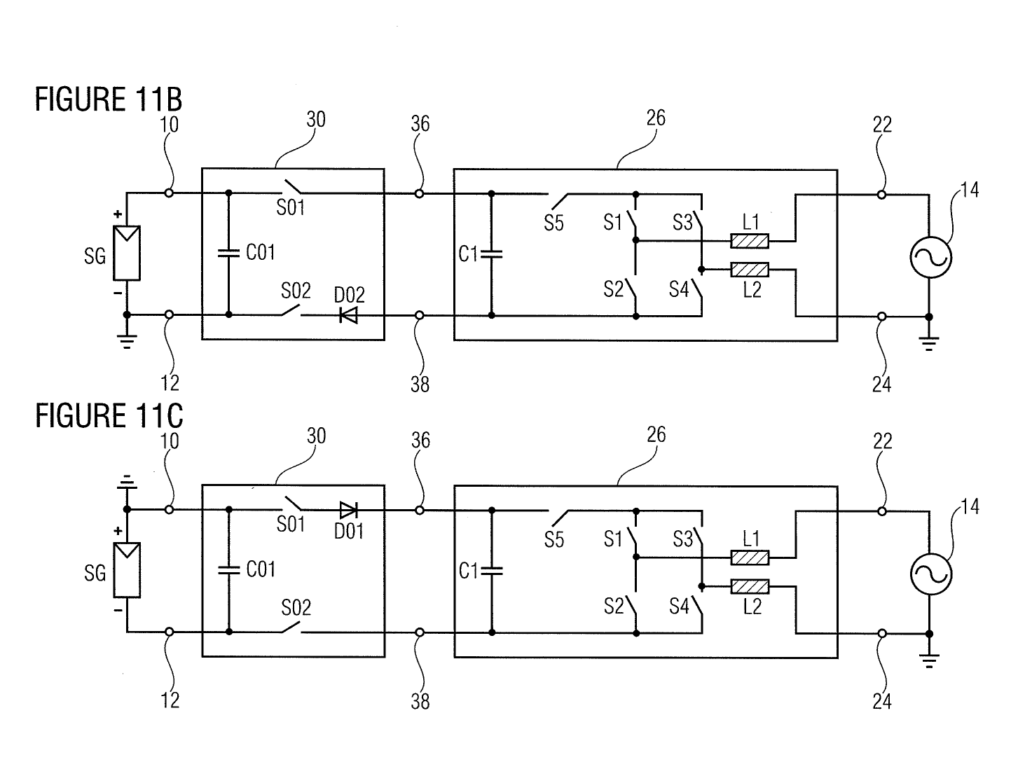

Based on FIG. 10, examples are described, according to which the isolating means according to FIG. 7(a), FIG. 7(b) or FIG. 7(c) is combined with the circuit according to FIG. 3 (see FIG. 10(a), FIG. 10(b) or FIG. 10(c)). Based on FIG. 11, examples are described, according to which the isolating means according to FIG. 7(a), FIG. 7(b) or FIG. 7(c) is combined with the circuit according to FIG. 4 (see FIG. 11(a), FIG. 11(b) or FIG. 11(c)).

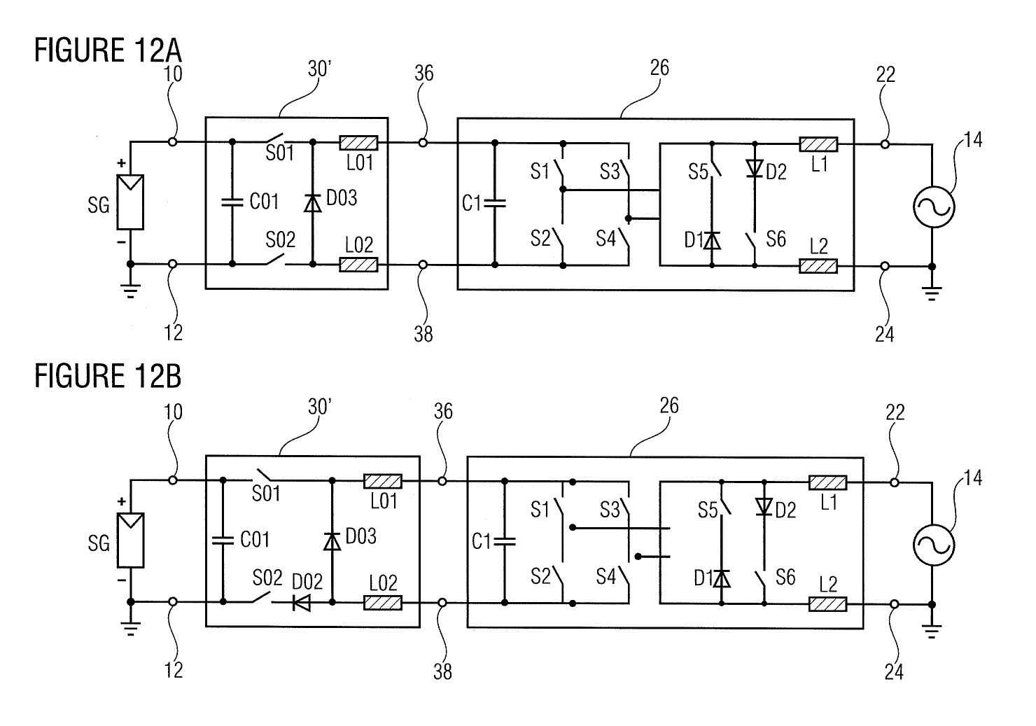

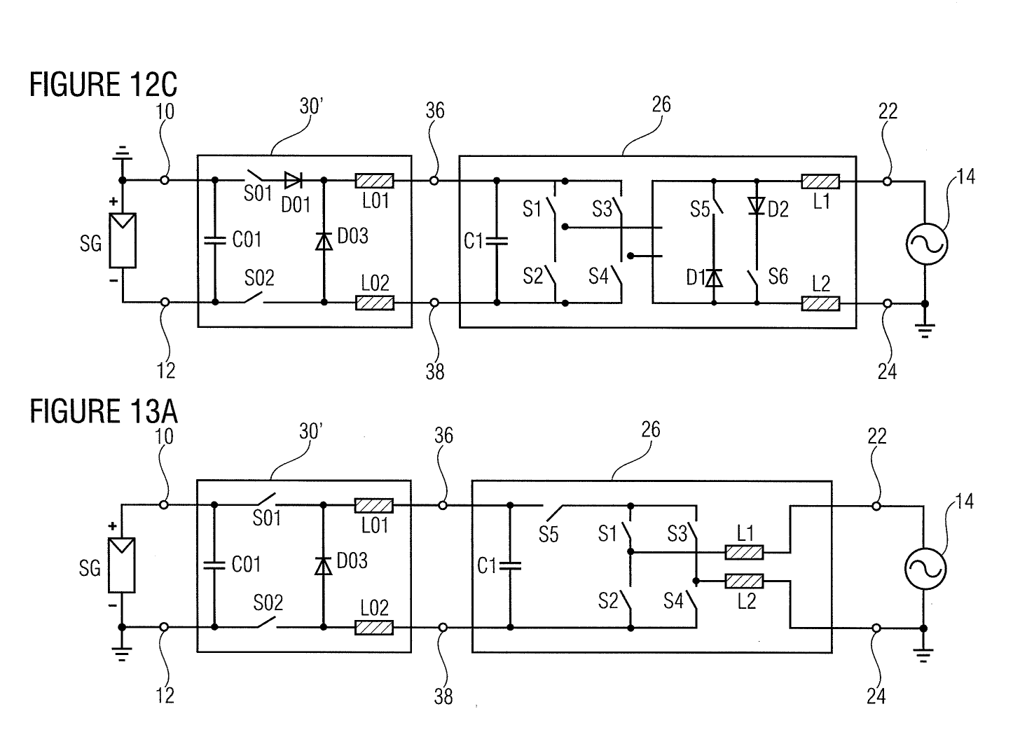

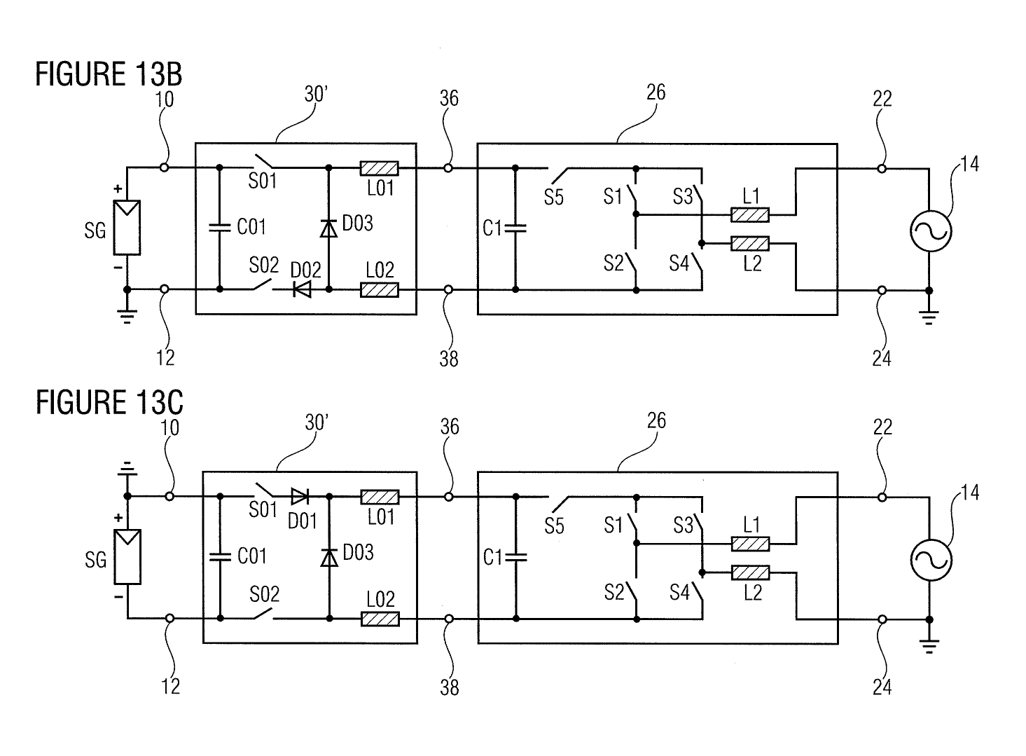

Based on FIG. 12, examples are described, according to which the isolating means according to FIG. 9(a), FIG. 9(b) or FIG. 9(c) is combined with the circuit according to FIG. 3 (see FIG. 12(a), FIG. 12(b) or FIG. 12(c)). Based on FIG. 13, examples are described, according to which the isolating means according to FIG. 9(a), FIG. 9(b) or FIG. 9(c) is combined with the circuit according to FIG. 4 (see FIG. 13(a), FIG. 13(b) or FIG. 13(c)).

FIGS. 10 and 12 show the coupling of the isolating means according to FIGS. 7 or FIG. 9 with the DC/AC converter circuit according to FIG. 3. During the freewheeling phase in the DC/AC converter, i.e. when the current flows through switches S5 or S6, the four bridge transistors S1 to S4 are turned off and there is no conductive connection between capacitor C₁ and mains 14. During this time, the capacitor C₁ can be recharged via switches S₀₁ and S₀₂. Thereby, its potential to ground jumps from the floating mains potential to the fixed solar generator potential.

FIGS. 11 and 12 show the combination of the isolating means according to FIG. 7 or FIG. 9 with the DC/AC converter according to FIG. 4. Freewheeling of the DC/AC converter is performed via transistors S1 and S3. During this phase, transistors S2, S4 and S5 are turned off and capacitor C₁ is potential-free. By switching on transistors S₀₁ and S₀₂ of the isolating means, the capacitor C₁ can be recharged in this phase. Thereby, the potential jumps to that of the solar generator.

Based on FIGS. 9, 12 and 13, embodiments have been described where two choke coils are provided. The present invention is not limited to this embodiment in practice for symmetry reasons. Alternatively, in these embodiments, only one choke coil can be provided.

While this invention has been described in terms of several advantageous embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. Isolating circuit for a DC/AC converter, wherein the DC/AC converter comprises an energy storage isolated from mains during a freewheeling phase, the isolating circuit comprising:
an input;
an output connectable to the DC/AC converter;
an energy storage element connected to the input and operative to store energy received from the input; and
a switching element connected between the energy storage element and the output, wherein the switching element is operative to connect the energy storage element to the output during the freewheeling phase of the DC/AC converter, and to isolate the energy storage element from the output outside the freewheeling phase of the DC/AC converter.

2. Isolating circuit according to claim 1, wherein
the input comprises a first terminal and a second terminal, and
the output comprises a first terminal and a second terminal,
wherein the energy storage element is connected between the first terminal and the second terminal of the input, and
wherein the switching element comprises a first switch connected between the first terminal of the input and the first terminal of the output, and a second switch connected between the second terminal of the input and the second terminal of the output.

3. Isolating circuit according to claim 2, comprising
a first choke coil connected between the first switch and the first terminal of the output;
a second choke coil connected between the second switch and the second terminal of the output; and
a freewheeling diode connected between a node between the first switch and the choke coil and a node between the switch and the choke coil.

4. Isolating circuit according to claim 2, wherein the energy storage element comprises a capacitor.

5. Isolating circuit according to claim 2, wherein the switches comprise electronic switches or transistors.

6. System comprising
a solar generator connected to a reference potential;
a DC/AC converter implemented to convert a DC voltage provided by the solar generator into an AC voltage and to provide it to an output of the DC/AC converter, wherein the DC/AC converter is further implemented to isolate an energy storage of the DC/AC converter from the output of the DC/AC converter during a freewheeling phase; and
an isolating circuit for a DC/AC converter, wherein the DC/AC converter comprises an energy storage isolated from mains during a freewheeling phase, the isolating circuit comprising:
an input;
an output connectable to the DC/AC converter;
an energy storage element connected to the input and operative to store energy received from the input; and
a switching element connected between the energy storage element and the output, wherein the switching element is operative to connect the energy storage element to the output during the freewheeling phase of the DC/AC converter, and to isolate the energy storage element from the output outside the freewheeling phase of the DC/AC converter.

7. System according to claim 6 comprising a power source implemented to provide the reference potential.

8. System according to claim 7, wherein the solar generator comprises the power source.

9. System according to claim 6, wherein the reference potential is ground.

10. System according to claim 6, wherein the solar generator comprises thin-film modules or rear-side contacted solar cells.

11. DC/AC converter circuit for converting a received DC voltage into an AC voltage, comprising
an input;
an output;
an energy storage;
a switching network connected between the energy storage and the output and operative to isolate the energy storage from the output during a freewheeling phase and to connect the energy storage to the output outside the freewheeling phase; and
an isolating circuit for a DC/AC converter, wherein the DC/AC converter comprises an energy storage isolated from mains during a freewheeling phase, the isolating circuit comprising:
an input;
an output connectable to the DC/AC converter;
an energy storage element connected to the input and operative to store energy received from the input; and
a switching element connected between the energy storage element and the output, wherein the switching element is operative to connect the energy storage element to the output during the freewheeling phase of the DC/AC converter, and to isolate the energy storage element from the output outside the freewheeling phase of the DC/AC converter,
connected between the input and the energy storage.

12. DC/AC converter circuit according to claim 11, wherein the switching network comprises a bridge circuit with four switches, a first choke coil connected between a first bridge tap and a first terminal of the output, a second choke coil connected between a second bridge tap and a second terminal of the output, and a parallel circuit between the first and second bridge taps comprising a first series connection of a first switch and a first rectifier diode and a second series connection of a second switch and a second diode connected opposed to the first diode,
wherein the switches of the bridge are open during the freewheeling phase.

13. DC/AC converter circuit according to claim 11, wherein the switching network comprises a bridge circuit with four switches, a first choke coil connected between a first bridge tap and a first terminal of the output, a second choke coil connected between a second bridge tap and a second terminal of the output, and a switch between the energy storage and the bridge,
wherein the switch and at least two of the bridge switches are open during the freewheeling phase.

14. Method for converting a DC voltage provided by a solar generator connected to a reference potential into an AC voltage, comprising:
outside a freewheeling phase of a DC/AC converter, when an energy storage connected to the input of the DC/AC converter is connected to an output of the DC/AC converter, isolating the solar generator from the DC/AC converter and temporarily storing the energy provided by the solar generator; and
during the freewheeling phase of the DC/AC converter, during which the energy storage of the DC/AC converter is isolated from the output of the DC/AC converter, charging the energy storage of the DC/AC converter.

15. Method according to claim 14, comprising:
providing an internal or external power source for the solar generator, which provides the reference potential.

16. Method according to claim 14, comprising:
grounding the solar generator.
